(19) United States
(12) Patent Application Publication
(10) Pub. No.: US 2021/0027373 A1
(43) Pub. Date: Jan. 28, 2021

(54) METHOD FOR INITIATING AND HOSTING AN AUCTION FOR A SECURITY

(71) Applicant: KopenTech LLC, Los Angeles, CA (US)

(72) Inventors: James August Vogl, Los Angeles, CA (US); Anthony Schexnayder, Long Beach, CA (US); Olga Chernova, New York, NY (US); Anna Gryb, Los Angeles, CA (US); Alexander Gryb, Los Angeles, CA (US); Beniamin Airapetian, Kharkiv (UA); Ievgen Shylenko, Kharkiv (UA)

(21) Appl. No.: 17/066,453

(22) Filed: Oct. 8, 2020

Related U.S. Application Data
(63) Continuation of application No. 16/820,349, filed on Mar. 16, 2020.
(60) Provisional application No. 62/819,442, filed on Mar. 15, 2019.

(51) Int. Cl. G06Q 40/04; G06Q 30/08

(52) U.S. Cl. CPC G06Q 40/04; G06Q 30/08

(57) ABSTRACT

One variation of a method for initiating and hosting an auction for a security includes: accessing historical trade data and characteristics of a corpus of securities traded on an auction platform; assigning post-auction liquidity scores to the corpus of securities based on historical trading result data; constructing a liquidity model representing correlations between characteristics and pre-auction liquidity scores of the corpus of securities; accessing characteristics of a security held by a seller; calculating a liquidity score of the security based on characteristics of the security and the liquidity model; assigning a rule profile—defining rules for distribution of feedback to bidders during an auction—to the security based on the liquidity score of the security; initiating an auction for the security on the auction platform; and, during the auction, distributing feedback for bids according to the rule profile.

### CROSS-REFERENCE TO RELATED APPLICATIONS

This application is a continuation application of U.S. patent application Ser. No. 16/820,349, filed on 16 Mar. 2020, which claims the benefit of U.S. Provisional Patent Application No. 62/819,442, filed on 15 Mar. 2019, each of which is incorporated in its entirety by this reference.

### TECHNICAL FIELD

This invention relates generally to the field of structured financial products and more specifically to a new and useful method for initiating and hosting an auction for a security in the field of structured financial products.

### BRIEF DESCRIPTION OF THE FIGURES

FIG. 1 is a flowchart representation of a method;

FIG. 2 is a flowchart representation of one variation of the method;

FIG. 3 is a flowchart representation of one variation of the method;

FIGS. 4A and 4B are flowchart representations of one variation of the method; and

FIG. 5 is a graphical representation of one variation of the method.

### BACKGROUND OF THE INVENTION

Traditionally, investment security notes across capital structures are traded via a manual, unstructured Bid Wanted In Competition (or “BWIC”) process, which is cumbersome, time-consuming, opaque for sellers (i.e., security holders) and buyers (e.g., broker-dealers, investors represented by broker-dealers, end-users). For example, under a traditional BWIC process, a seller may: identify a list of securities—each including a portion or “slice” of a tranche within a security—within her portfolio that she is interested in selling in order to generate liquidity; manually stack-rank these securities according to her predictions for auction success or predicted liquidity of these securities; manually compile a list of these securities into a spreadsheet; manually send this spreadsheet—such as within an email, text message, or online forum post—to a group of (e.g., 30) broker-dealers whom the seller anticipates will be interested in purchasing these securities for inventory or on behalf of their clients (or “end users”); and request bids from broker dealers within a period of time (e.g., two hours, 24 hours). Broker-dealers who receive this communication from the seller may then return bids to the seller via email, telephone, forum message, or text message. The seller may respond manually to some or many of these bidders and engage in individual negotiations for access to bid feedback and bid improvement with these individual bidders.

Therefore, this process may overwhelm even teams of sophisticated investment professionals who manually track bids inbound from broker-dealers on multiple securities during a narrow (e.g., two-hour) auction window. Such a team may therefore be likely to miss or overlook best bids from bidders. This process may also be opaque and unpredictable for bidders, may preclude end users from direct access to these securities, may result in lower final BWIC auction prices for these securities, and may impaired a seller's ability to sell securities entirely via BWIC auctions.

In particular, this manual process may present: a poor opportunity for consistent feedback for all bidders; a poor opportunity for bid improvement from bidders; poor accessibility to securities for end-users; poor transparency for bidders; and require extensive manual effort from sellers and buyers alike to reach successful auction close.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

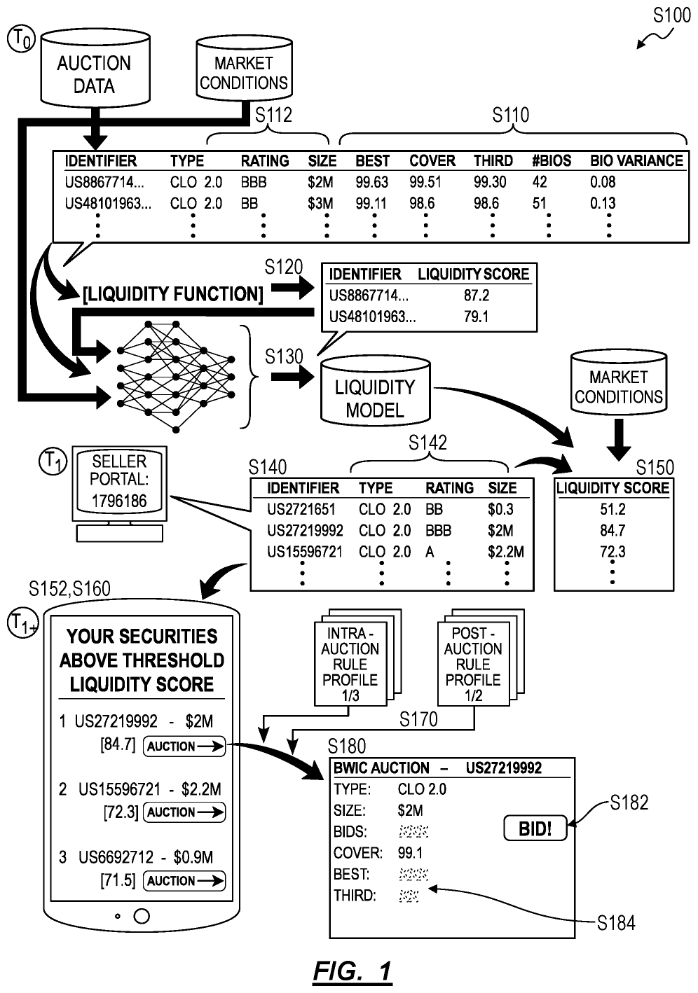

As shown in FIGS. 1-3, a method S100 for initiating and hosting an auction for a security includes: accessing historical auction result data for a corpus of securities auctioned on a platform in Block Silo; accessing characteristics of the corpus of securities in Block S112; calculating liquidity scores at time of auction for the corpus of securities based on historical auction result data for the corpus of securities in Block S120; and constructing a liquidity model representing correlations between characteristics of securities and to liquidity scores in Block S130. The method S100 also includes, during a current period of time: accessing a set of marketable securities held by a seller in Block S140; accessing characteristics of the set of marketable securities in Block S142; estimating liquidity scores of the set of marketable securities based on characteristics of the set of marketable securities and the liquidity model in Block S150; ranking the set of marketable securities by liquidity score in Block S152; and prompting the seller to elect a subset of securities from the ranked set of marketable securities to auction in Block S160. The method S100 further includes, in response to election of a particular security from the ranked set of marketable securities to auction by the seller: selecting a rule profile, from a set of predefined rule profiles, based on a characteristic of the seller in Block S170, the predefined rule profile specifying rules for improvement of bids by bidder and distribution of feedback to bidders during an auction for the particular security; and initiating an auction for the security in Block S180. Furthermore, the method S100 includes, during the auction for the security: recording bids according to rules for improvement specified in the rule profile in Block S182; and distributing feedback for recorded bids to bidders according to rules for distribution of feedback specified in the rule profile in Block S184.

One variation of the method S100 includes: accessing historical trading result data for a corpus of securities traded on an auction platform in Block Silo; accessing characteristics of the corpus of securities in Block S112; assigning liquidity scores to securities in the corpus of securities at time of auction on the auction platform based on historical trading result data for the corpus of securities in Block S120; and constructing a liquidity model representing correlations (e.g., statistical relationships) between characteristics and liquidity scores of securities in the corpus of securities in Block S130. This variation of the method S100 also includes, during a first time period: accessing characteristics of a set of securities held by a seller in Block S142; for each security in the set of securities, calculating a liquidity score of the security based on characteristics of the security and the liquidity model in Block S150; and ranking the set of securities based on liquidity score in Block S152. This variation of the method S100 further includes, following election of a first security, in the set of securities for auction, by the seller of: assigning a first rule profile to the first security in Block S170, the first rule profile defining rules for bid improvement and rules for distribution of feedback to bidders during an auction for the first security; and initiating an auction for the first security in Block S180. This variation of the method S100 also includes, during the auction for the first security: recording a first bid, entered by a first bidder at a bidder portal, according to rules for improvement specified in the first rule profile in Block S182; and distributing feedback for the first bid, via the bidder portal, to the first bidder according to rules for distribution of feedback specified in the first rule profile in Block S184.

Another variation of the method S100 includes: accessing historical trading result data for a first corpus of securities traded on an auction platform in Block Silo; accessing characteristics of the first corpus of securities in Block S112; assigning liquidity scores to securities in the first corpus of securities at time of auction on the auction platform based on historical trading result data for the first corpus of securities in Block S120; and constructing a first liquidity model representing correlations between characteristics and liquidity scores of securities in the first corpus of securities in Block S130. This variation of the method S100 also includes, during a first time period: accessing characteristics of a first security held by a seller in Block S142; calculating a first liquidity score of the first security based on characteristics of the first security and the first liquidity model in Block S150; and assigning a first rule profile to the first security based on the first liquidity score of the first security in Block S170, the first rule profile defining rules for distribution of feedback to bidders during an auction for the first security. This variation of the method S100 further includes: initiating the auction for the first security on the auction platform in Block S180; and, during the auction for the first security on the auction platform recording a first bid entered by a first bidder at a bidder portal at a first time in Block S182 and distributing feedback for the first bid, via the bidder portal, to the first bidder at approximately the first time according to rules for distribution of feedback specified in the first rule profile in Block S184.

Yet another variation of the method S100 includes, for each security in a set of securities held by a seller: querying a group of investors affiliated with an auction platform for price talk for the security; and calculating a liquidity score for the security based on a spread of price talk returned by the group of investors for the security. This variation of the method S100 also includes: selecting a first security, in the set of securities, based on a first liquidity score of the first security; assigning a first rule profile to the first security based on the first liquidity score of the first security in Block S170, the first rule profile defining rules for distribution of feedback to bidders during an auction for the first security; and initiating an auction for the first security on the auction platform in Block S180. This variation of the method S100 further includes, during the auction for the first security on the auction platform: recording a first bid entered by a first bidder at a bidder portal at a first time in Block S182; and distributing feedback for the first bid, via the bidder portal, to the first bidder at approximately the first time according to rules for distribution of feedback specified in the first rule profile in Block S184.

### 2. Applications

Generally, a computer system can execute Blocks of the method S100 to derive correlations between: liquidity of securities (e.g., segments of debt or equity tranches in collateralized loan obligations, or “CLOs”; leveraged loans; asset- and mortgage-backed securities; other structured products) traded on an auction platform; and characteristics of these securities, market conditions during these auctions, etc. The computer system can execute Blocks of the method S100 to generate a “liquidity model” (e.g., a parametric or non-parametric model) that represents these correlations. For example, “liquidity” may include an aggregate quantitative value or “score” representative of price, bid quantity, unique bidder quantity, bid frequency, bid variance, and/or auction success for a security auctioned on the auction platform.

The computer system can then implement this liquidity model and known characteristics of a security held by a seller to predict a current liquidity of this security, which represents a probability that the security will successfully trade on the auction platform, such as given current market conditions. The computer system can repeat this process for (many) securities held by this seller and rank these securities in order of their liquidity scores, and then present this ranked list of securities to the seller via a seller portal, such as accessible within a native application or web browser executing on the seller's computing device. The seller may then review these liquidity scores: to identify a security most likely to sell at auction at reasonable or high prices; or to identify a security that recently became more liquid after a period of low liquidity. Accordingly, the seller may initiate an auction for a particular security—in this ranked set—to enable other investors (e.g., broker-dealers, buyers, individual investors, end-users) to bid on this particular security.

Once the seller elects to auction a security on the platform, the computer system can interface with the seller to define pre-auction rules (e.g., early trading), intra-auction rules (e.g., feedback policy, improvement, update frequency), and post-auction rules (e.g., color to bidders and the market) for this auction, such as by: automatically assigning a particular predefined rule profile to the auction based on a characteristic of the security; modifying the predefined rule profile based on a characteristic of the seller; and further adjusting the predefined rule profile based on price talk received from investors on the auction platform for the security (or for similar securities).

The computer system can also implement similar methods and techniques to calculate a bidder score for an investor on the auction platform, which represents a likelihood of bid submission, bid depth, and/or bid improvement by this investor during an auction for this security based on historical bids and trades made by the investor during previous auctions on the auction platform. The computer system can then recommend that the seller enable early bidding on the security for particular investors who exhibit high bidder scores or otherwise market the security to these particular investors.

Once the seller confirms the auction for the security and corresponding pre-, intra-, and post-auction rules, the computer system can initiate a Bid Wanted In Competition (or “BWIC”) auction for the security according to these rules, including: recording bids entered by investors; limiting bid improvement by these investors according to improvement rules assigned to the security; selectively presenting feedback to bidders according to feedback rules assigned to the security; and publishing color for the auction to bidders and the market more generally upon conclusion of the auction according to color rules assigned to the security. Finally, the computer system can initiate, verify, settle, or otherwise handle exchange of securities and monies between the seller and select bidders to complete this BWIC auction and transaction for the security.

Therefore, by defining clear rules for auctioning this security, posting these rules within the auction, and executing these rules automatically during this auction according to Blocks of the method S100, the computer system can: improve transparency of this BWIC auction for both the seller and investors on the auction platform, thereby increasing demand for the security, increasing access to the security, increasing a price of the security, and ultimately increasing liquidity of the security.

### 2.1 Automated BWIC

Generally, the computer system can execute Blocks of the method S100 to automatically: predict liquidity of securities held by a seller based on characteristics of these securities, historical auction results on an auction platform, price talk from investors on the auction platform, and/or current market conditions; automatically rank or recommend securities for BWIC auction to the seller based on their predicted liquidities (which may represent predictions for success of auctions for these securities and/or final bid prices or levels for these securities); define rules for improvement and feedback for bids and bidders during an auction for one of these securities; define rules for publishing or serving color for results of an auction for this security to bidders and/or to the market; automatically enable bid improvement and distribute feedback according to these rules during this auction; and automatically distribute color according to these rules following conclusion of this auction.

By thus executing Blocks of the method S100, the computer system can: streamline BWIC auctions for securities held by the seller; increase likelihood of success for BWIC auctions by improving timing and selection of securities for auction; increase access to bidding on the security and thus increase frequency of bidding by investors on the auction platform; enforce greater transparency and fairness for all bidders in a BWIC auction; reduce time spent managing bids in a BWIC auction for both sellers and bidders; and reduce probability of missed bids.

### 2.2 Terms

The method S100 is described herein as executed by a computing device to host BWIC auctions in which broker-dealers bid—on behalf of debt investors—for securities. However, the computer system can execute Blocks of the method S100 to host debt tranche auctions in which individual investors—such as in addition to or instead of broker-dealers—bid for securities.

Furthermore, the method S100 is described herein as executed by the computer system to support trades of debt within a new, reissue, or existing arbitrage collateralized loan obligation (or a “CLO”). However, the method S100 can additionally or alternatively be executed by the computer system to support trading of new-issue, reissue, or existing structured or securitized product investments, such as: leveraged loans; asset-backed securities; commercial mortgage-backed securities; and/or residential mortgage-backed securities.

The computer system can execute Blocks of the method S100 to host time-limited “marketplaces,” “listings,” or other sale formats in which broker-dealers (or investors more generally) may place bids or claims for debt in a security.

An “investor” described herein encompasses end-users, broker-dealers trading for their own accounts, broker-dealers trading on behalf of clients (e.g., end-users), and/or other investors and investment entities.

“Feedback” described herein includes: assessment of bid price or level provided to a bidder following submission of a bid, such as whether the bid is a top bid, within the top three bids received, or outside of the top three bids received during an auction; and distribution of bid price and/or level updates to bidders while an auction is pending, such as whether a top-three bid previously placed by a bidder was superseded by a more recent bid or whether a reserve has been met by a recent bid.

“Color” described herein includes bid price, bid level, and/or general auction outcome data provided to bidders and/or published for the market more generally following conclusion of an auction. For example, “color” can include confirmation that a security “traded” or “did not trade” (or “DNT”) and the final bid price and bid level for this security.

“Price talk” described herein includes suggested (or “ballpark”) bids prices or levels anticipated and provided by investors for a security prior to an auction for the security.

“Liquidity” described herein includes a probability, ability, or propensity to complete a trade (or “sale”) of a security, such as independently or in light of a size and level of the security.

### 3. Auction Platform

As shown in FIG. 1, the computer system can include a computer server or a computer network and can host an auction platform accessible by a large population of investors (e.g., both large and small broker-dealers, individual investors) place bids for securities—that is portions or “slices” of debt tranches in CLOs or other asset-backed securities. For example, the computer system can host auctions—on the auction platform—visible to an investor via a bidder portal accessed through a native application or web browser executing on a desktop computer or mobile device.

The computer system can also maintain a global whitelist of verified investors permitted to place bids for securities on the auction platform. The computer system can additionally or alternatively maintain a global blacklist of investors not permitted to place bids for securities on the auction platform, such as broker-dealers who failed to settle bids for previous auctions on the platform. The computer system can also maintain global investor bid limits, such as in bidder profiles for whitelisted investors and based on size and/or bid history of these investors. Additionally or alternatively, the computer system can maintain security-specific bid limits for individual investors—that is, maximum bid levels and bid prices that a particular investor is permitted to enter for a particular security or group of securities exhibiting particular characteristics.

The computer system can similarly: maintain a list, table, or other database of maximum bid values or verified bid ranges (e.g., minimum and maximum bid values) available to investors on the auction platform; and selectively whitelist and blacklist individual investors for an auction of a particular security—selected for trading by a seller—based on a size of this security and maximum bid values or verified bid ranges of these investors.

Furthermore, the computer system can host a seller portal accessible by a seller—via a native application or web browser executing on a desktop computer or mobile device—to view securities held by the seller, to review liquidity scores calculated by the computer system for these securities, to confirm rules and BWIC auctions for these securities, to view real-time progress of these auctions, and to review and settle final results of these auctions.

### 4. Model Generation

Blocks S110, S112, S120, and S130 of the method S100 recite, respectively: accessing historical trading result data for a first corpus of securities traded on an auction platform; accessing characteristics of the first corpus of securities in Block S112; assigning liquidity scores to securities in the first corpus of securities at time of auction on the auction platform based on historical trading result data for the first corpus of securities in Block S120; constructing a first liquidity model representing correlations between characteristics and liquidity scores of securities in the first corpus of securities. Generally, in Blocks S110, S112, S120, and S130, the computer system can aggregate: characteristics (e.g., size, rating) of securities previously traded on the auction platform; results of these auctions (e.g., final bid price, final bid level, quantity and range of bids, quantity of unique bidders); and/or market characteristics before or during these auctions, etc. The computer system can then implement deep learning, artificial intelligence, regression, and/or other methods to: derive correlations between security characteristics, auction results, and market conditions; and to represent these correlations in a liquidity model (or a liquidity model more generally) that predicts results (e.g., final bid price or level, quantity and range of bids) of a future auction for another security based on current (or projected future) market conditions and characteristics of this security.

### 4.1 Historical Auction Data

In one implementation, the computer system queries a database of security auction results for characteristics of securities previously traded on the auction platform in Block 112. For example, for each security previously auctioned on the auction platform, the computer system can retrieve: an identifier and/or characteristics of a CLO asset manager for a CLO containing the security; a size of the CLO or particular tranche in the CLO; an identifier of the CLO itself; a CLO tranche containing the security or a rating to the security; the vintage of the CLO containing the security (e.g., the CLO creation or indenture date, month, or year); and/or a that security is traded on the auction platform; etc.

For these same securities, the computer system can also retrieve auction feature outcomes of past BWIC auctions in Block S110. For example, for each security previously traded on the auction platform, the computer system can access past auction data including: total number of unique bidders participating; frequency of bids; submitted bid prices; depth of bids; final bid price; a difference between final bid price and reserve; whether the auction was successful; and/or whether a final bid price was accepted by the seller; etc.

The computer system can also derive additional data from these inter-auction data. For example, the computer system can calculate a bid variance (or “dispersion” or “spread” of bids) for bids placed during a past auction for a security. In this example, a tight cluster of bid prices—corresponding to low bid distribution or variation or narrow “spread”—may indicate that bidders were confident in and/or knowledgeable of an “appropriate” market price for the security at time of auction. However, a wide range of bid prices—corresponding to high bid variance or wide “spread”—may suggest that bidders were: “guessing” at an appropriate market price for the security; and/or bidding in order to access information (i.e., color and/or feedback) about other bidders' behaviors during the auction.

For these same securities, the computer system can also access market conditions before and/or during the auctions for these securities, such as market performance for the day, week, month, or year leading up to these BWIC auctions for securities on the auction platform. In another example, the computer system can retrieve price talk data submitted for these securities by investors on the auction platform prior to past auctions for these securities.

However, the computer system can access any other historical auction data for securities traded on the auction platform in Blocks S110 and S112.

### 4.2 Liquidity Score

The computer system can then calculate a liquidity score for each of these securities based on the foregoing data in Block S120.

In one implementation, the computer system implements a liquidity function to transform the foregoing data for a security into a liquidity score (e.g., on a scale from “0” to “100”) of the security. For example, the computer system can calculate a higher liquidity score for the security at the time of the auction if the auction for the security was successful. Similarly, the computer system can calculate a liquidity score for the security: proportional to a difference between a final bid price and a reserve price for the security; inversely proportional to bid variance for the auction; and proportional to bid depth and a number of unique bidders during the auction. In this implementation, the computer system can also calculate a liquidity score for the security based on a weighted combination of these factors, such as by assigning: a greatest weight to success of the auction; a second-greatest weight to the difference between final and reserve prices; a third-greatest weight to depth of bids; and a fourth-greatest weight to bid variance.

In a similar example, the computer system accesses trade statuses and bid prices placed during previous auctions for securities completed on the auction platform in Block S110. The computer system then accesses sizes and ratings of these previously-auctioned securities in Block S112. For each security in this corpus of previously-auctioned securities, the computer system assigns a post-auction liquidity score to the security: inversely proportional to a spread of bid prices placed during a previous auction for the security; proportional to a quantity of unique bidders who placed bids during the previous auction for the security; proportional to a quantity of placed bids during the previous auction for the security; and/or based on a trade status of the previous auction for the security (e.g., proportional to a difference between a final bid price and a reserve price set by the corresponding seller). In Block S130 described below, the computer system then constructs a liquidity model that represents correlations between: post-auction liquidity scores assigned to these previously-auctioned securities; and sizes and ratings of these securities.

The computer system can also normalize the liquidity score calculated for a security—previously traded on the auction platform—based on improvement limitation and feedback distribution rules implemented during the auction. For example, the computer system can increase the liquidity score calculated for this security if rules implemented during the past auction specified limited or no bid improvement for bidders; and vice versa. Similarly, the computer system can increase the liquidity score calculated for this security if rules implemented during the past auction specified limited feedback for top bidders only and/or infrequent or no updates for bidders during the auction; and vice versa.

The computer system can repeat this process for each other security traded on the auction platform.

### 4.3 Liquidity Model

As shown in FIG. 1, the computer system can then implement clustering techniques, regression analysis, deep learning, artificial intelligence, and/or other techniques to derive and model correlations between security characteristics, market conditions, liquidity scores, and/or more specific inter- and post-auction results for these previously-auctioned securities.

### 4.3.1 Non-Parametric Liquidity Models

In one implementation, the computer system: represents a security previously auctioned on the auction platform as a vector containing values corresponding to characteristics of the security and market conditions during and/or preceding the auction for the security; and labels this vector with the liquidity score of this security. The computer system repeats this process for other securities previously auctioned on the auction platform to generate a corpus of vectors representing a history of auctions completed on the auction platform and then groups vectors labeled with similar liquidity scores. For example, the computer system can group these vectors into a preset number of groups, such as ten groups with liquidity scores from 0-10, 10.1-20, 20.1-30, . . . , and 90.1-100. In another example, the computer system implements elbow method, silhouette method, or gap static method, and/or other techniques to cluster these vectors into any other quantity of substantially distinct groups (or “liquidity score groups”).

In this implementation, the computer system can then: calculate ranges, means, variances, standard deviations, and/or other metrics for each security characteristic and market condition dimension within a liquidity score group; and store these metrics in the form of a non-parametric liquidity model labeled with a range of liquidity scores of vectors within this liquidity score group. The computer system can repeat this process for each other liquidity score group to generate a set of non-parametric liquidity models, each: labeled with a liquidity score range (or an average liquidity score); and representing security characteristic and market condition metrics of vectors in this liquidity score group. Later, the computer system can estimate or calculate a pre-auction liquidity score for a target security held by a seller by: retrieving characteristics of the target security and current market conditions; querying the set of non-parametric liquidity models to identify a particular liquidity score group associated with security characteristics and market condition metrics that approximate or contain security characteristics of the target security and current market conditions; and then assigning the liquidity score of this particular liquidity score group to the target security.

Similarly, the computer system can: derive an average or representative value in each range of security characteristics and market conditions for securities in a liquidity score group; store these average or representative values in the form of a “template liquidity image” for the liquidity score group; and repeat these process for each other liquidity score group to generate a set of template liquidity images. Later, the computer system can derive a pre-auction liquidity score for a target security held by a seller by: retrieving characteristics of the target security and current market conditions; querying the set of template liquidity images to identify a particular template liquidity image containing representative values nearest each corresponding characteristic of the target security given current market conditions; and then assigning the liquidity score associated with this particular template liquidity image to the target security.

### 4.3.2 Parametric Liquidity Model

In another implementation, the computer system implements artificial intelligence, deep learning, or other techniques: to derive correlations (or “relationships”) between values contained in this set of vectors representative of securities previously auctioned on the auction platform; and to fuse these correlations into a parametric liquidity model configured to ingest (current or forecast) market conditions and characteristics of a security and to output a pre-auction liquidity score for this security. Later, the computer system can assess the liquidity of a target security by: accessing characteristics of the security and current market conditions; and passing these security characteristics and market conditions directly into the parametric liquidity model, which then returns a pre-auction liquidity score for the target security.

However, the computer system can implement any other method or technique to derive correlations between security characteristics, market conditions, and liquidity scores and to represent these correlations in parametric and/or non-parametric liquidity models.

### 4.4 Other Security Characteristics

The computer system can implement similar methods and techniques to derive correlations between post-auction liquidity scores and: structural characteristics of the security (e.g., a non-call period, subordination, a reinvestment period); collateral quality characteristics (e.g., % of CCC loan, % of second lien loans, % of stressed sectors, % of small issuers, % of securities without prices); security manager and/or seller characteristics (e.g., tier and ranking of managers based on AUM, past performance, and market perception); and current demand (e.g., based on current and recent sell-through rate and other characteristics of auctions hosted on the auction platform). The computer system can then construct or modify the liquidity model to further reflect these correlations.

### 4.5 Auction Outcome Modeling

The computer system can implement similar methods and techniques to derive correlations between: the foregoing security characteristics and market conditions; and auction outcomes, such as bid price, bid depth, bid variance, number of bids, and auction result. The computer system can then fuse these correlations into an auction outcome model that predicts probabilities of ranges of final bid prices, final bid prices, bid depths, bid variances, and/or total quantity of bids, etc. for an auction of a security as a function of (current or forecast) market conditions and characteristics of the security.

For example, to calculate a liquidity score of a security held by the seller, the computer system can input characteristics of the security and (current or forecast) market conditions into the auction outcome model. The auction outcome model then returns a distribution (e.g., a range) of predicted final bid prices and their probabilities based on these security characteristics and market conditions. (Alternatively, a non-parametric auction outcome model can return a distribution of final bid prices of previously-auctioned securities (e.g., within a liquidity score group) associated with security characteristics and past market conditions nearest characteristics of the security and the current market conditions, respectively.) The computer system can then pass these outputs of the auction outcome model into the liquidity model, which calculates a liquidity score for the security: proportional to a frequency of predicted final bid prices that exceed a reserve price set by the seller; and/or inversely proportional to a frequency of predicted final bid prices that fall below the reserve price set by the seller. Additionally or alternatively, the liquidity model can calculate a liquidity score for the security: proportional to an integral of predicted final bid prices and probabilities of these final bid prices for predicted final bid prices that exceed the reserve price; and/or inversely proportional to an integral of predicted final bid price and probabilities of these final bid prices for predicted final bid prices that fall below the reserve price. Therefore, in this example, the computer system can leverage the auction outcome model and the liquidity model to calculate a pre-auction liquidity score for a security based on a probability that a final bid price in an auction for this security will exceed a reserve set by the seller, such as predicted based on final bid prices of other securities exhibiting similar characteristics and previously auctioned under similar market conditions.

### 4.5 Auction Rule Modeling

The computer system can implement similar methods and techniques to: derive correlations between: auction rules (e.g., improvement, feedback, and color rules) for previously-auctioned securities; and post-auction liquidity scores for these securities. The computer system can then incorporate these correlations into the liquidity model described above such that the liquidity model returns a pre-auction liquidity score for a security as a function of proposed auction rules for this security.

For example, the computer system can: select a security held by the seller; select a set of rules for an auction of this security; input these rules, security characteristics, and current market conditions into the liquidity model, which returns a pre-auction liquidity score for this security; iteratively perturb these auction rules to re-calculate liquidity scores for the security; and then present to the seller a final set of auction rules that maximize the liquidity score of the security.

Additionally or alternatively, the computer system can derive correlations between: auction rules (e.g., improvement, feedback, and color rules) for previously-auctioned securities; auction results for these securities; and security characteristics and market conditions. The computer system can then fuse these correlations into a rules model that predicts absolute or normalized auction outcomes (e.g., bid price, bid depth, bid variance, number of bids) for a security as a function of auction rules, security characteristics, and market conditions. For example, once a seller elects to auction a particular security based on a liquidity score calculated for the security according to the liquidity model, the computer system can: select a set of rules for an auction of this security; input these rules, security characteristics, and current market conditions into the rules model, which returns predicted auction results for this security; iteratively perturb these auction rules to re-calculate auction result predictions for the security; and then present to the seller a final set of auction rules predicted to maximize auction results (e.g., final bid price) for the security. Alternately, the computer system can enable the seller to manually enter or select auction rules for the particular security, and the computer system can present an auction outcome for this security predicted by the rule model for these auction rules.

### 4.6 Liquidity Model Refinement

The computer system can also repeat the foregoing process to refine the liquidity model (and the auction outcome model, the rules model) over time as additional securities are traded on the auction platform, such as: hourly; daily; weekly; in response to completion of each BWIC auction or a minimum number of consecutive BWIC auctions on the auction platform; in response to a significant difference between a pre-auction liquidity score calculated for a security and a final auction result (e.g., auction success, final bid price) of this security; in response to prescribed or threshold changes in market conditions; or in response to broker-dealers creating markets in CLOs or other asset classes.

### 5. Autonomous Liquidity Assessment

Blocks S140, S142, and S150 of the method S100 recite, during a current period of time: accessing a set of marketable securities held by a seller; accessing characteristics of the set of marketable securities; and estimating liquidity scores of the set of marketable securities based on characteristics of the set of marketable securities and the liquidity model. (Block S142 and S150 can similarly recite: accessing characteristics of a first security held by a seller; and calculating a first liquidity score of the first security based on characteristics of the first security and the first liquidity model, respectively.) Generally, in Blocks S140, S142, and S150, the computer system can: assess the current liquidity of a security held by a seller based on the liquidity model generated in Block S130 and characteristics of this security; and then represent this liquidity in the form of a liquidity score, as shown in FIG. 1.

### 5.1 Security Portfolio

In one implementation, a seller links or loads identifiers of securities she holds or manages to her seller account on the auction platform. The seller may also purchase securities on the auction platform; accordingly, the computer system can automatically link these securities to the seller's account.

### 5.2 Liquidity Check

The computer system can execute a liquidity check to test liquidity scores of securities listed in the seller's account: when manually triggered by the seller via the seller portal; and/or regularly, such as once per week, once per weekday, or once per weekday morning, and again every weekday afternoon.

During a liquidity check, the computer system can: retrieve current and/or recent market conditions; select a security held by the seller; retrieve characteristics of the security (e.g., CLO, CLO vintage, CLO manager, security size, etc.); and input the characteristics of the security and current market conditions into the liquidity model to calculate a liquidity score for the security.

For example, for each security held by the seller, the computer system can: implement template matching techniques to match characteristics of the security and current market conditions to a small set of (e.g., one, three) nearest template liquidity image; calculate a combination (e.g., an average) of these liquidity scores, such as weighted by time since completion of corresponding auctions on the auction platform; and store this combination as the liquidity score for the security.

In another example, the computer system can: compile characteristics of the security (and current market conditions) into a target vector; implement the non-parametric liquidity model described above to isolate a cluster of vectors—representing past auctions on the auction platform—nearest the target vector in an n-dimensional security characteristic feature space; calculate a combination (e.g., an average) of liquidity score stored with vectors in this cluster, such as weighted by time since completion of corresponding auctions on the auction platform; and then store this combination as the liquidity score for the security.

In yet another example, the computer system passes characteristics of the security (e.g., rating, size, non-call period, subordination, reinvestment period, % of CCC loan, % of second lien loans, % of stressed sectors, % of small issuers, and/or tier and ranking of the security manager) and current market conditions into the parametric liquidity model described about, which directly returns a liquidity score of the security.

In the foregoing examples, the computer system can also input these characteristics of the security and current market conditions into an auction outcome model described above in order to predict a number of bids, a bid depth, a bid variance, and/or a final bid price (or probabilities of a range of the foregoing metrics) for an auction for the security. Additionally or alternatively, the computer system can prompt the seller to enter a minimum price that she would accept for the security (e.g., a “reserve” price) or retrieve this stored minimum price for the security from the seller's account. The computer system can then implement methods and techniques described above to calculate a liquidity score for the security based on: whether a particular final bid price predicted for an auction for the security exceeds this reserve price; calculated probabilities of final bid prices for the security that exceed this reserve price versus probabilities of final bid prices for the security that fall below this reserve price; and/or a predicted frequency of predicted final bid prices that exceed this reserve price versus a predicted frequency of predicted final bid prices that fall below this reserve price; etc. Yet alternatively, the computer system can: implement the liquidity model to calculate a liquidity score for the security; implement the auction outcome model described above to predict a final bid price (or a distribution and/or probabilities of final bid prices) for the security; and adjust (i.e., increase or decrease) the liquidity score of the security based on whether the predicted final bid price (or distribution of predicted final bid prices, probabilities of final bid prices) exceeds the reserve price for the security.

However, the computer system can implement any other method or technique to quantify or qualify liquidity of security held by the seller. The computer system can then repeat this process for each other security held by the seller.

### 5.3 Security Size

The computer system can also adjust (or “normalize”) a liquidity score of a security based on a size of the security, such as by decreasing the liquidity score for a larger security and vice versa.

For example, the computer system can implement methods and techniques described above to calculate a liquidity score for a security—held by the seller—based on the liquidity model. The computer system can also calculate a ratio: of a size of this security held by the seller; to an average size of similar securities trade on the auction platform. The computer system can then divide the liquidity score of the security by this ratio (or otherwise adjust the liquidity score of the security as a function of this ratio), thereby normalizing the liquidity score of the security according to a size of the security.

### 5.4 Tiering

In one variation, the computer system adjusts (or “normalizes”) the liquidity score of a security based on characteristics of the seller. For example, for a first seller who represents a small hedge fund, the computer system can reduce liquidity scores calculated for securities held by the first seller such that these liquidity scores reflect a small market or social signal of this first seller. Conversely, for a second seller who represents a large pension fund or a bank, the computer system can increase liquidity scores calculated for securities held by the second seller such that these liquidity scores reflect a greater market or social signal of this second seller.

### 5.5 Price Talk

In one variation, the computer system: queries a group of investors affiliated with the auction platform for price talk for a security; and adjusts a pre-auction liquidity score of the security based on price talk returned by these investors.

For example, prior to a scheduled liquidity check, the computer system can push a query for price talk for a security to investors on the auction platform. Then, during the scheduled liquidity check, the computer system can: implement methods and techniques described above to calculate a liquidity score for the security; aggregate any price talk returned by these investors; calculate a spread (or variance, distribution) of this price talk for the security; and adjust the liquidity score of the security inversely proportional to the spread of this price talk. Additionally or alternatively, the computer system can adjust the liquidity score of the security as a function of (e.g., proportional to) a proportion and or a magnitude of predicted final bid prices—suggested in this price talk—that exceed a reserve assigned to this security by the seller. (Yet alternatively, the computer system can calculate a liquidity score for the security based predominately or solely on price talk returned by these investors, such as according to the foregoing functions.)

Furthermore, in this variation, the computer system can implement methods and techniques described below to calculate bidder scores for investors on the auction platform and/or to estimate depths of bids for the security by investors on the auction platform; select a subset (e.g., ten) of these investors associated with highest bidder scores and/or greatest bid depths; and selectively prompt this subset of investors to return price talk for the security. Alternatively, the computer system can: prompt many or all investors on the auction platform for price talk for the security; and weight price talk returned by the investors according to their corresponding bidder scores and/or estimated bid depths for the security.

### 5.6 Marketable Securities

In one variation, the computer system can implement similar methods and techniques to quantify or qualify liquidity of a subset of securities held by the seller and previously labeled as “marketable” (e.g., available for trade, considered for trading) by the seller.

For example, when considering initiating a BWIC auction to trade securities for liquidity, the seller may: access her account on the auction platform; navigate to a list of her securities; select a subset of these securities that she prefers or is considering trading on the auction platform; and manually trigger assessment of this subset of securities by the computer system. The computer system then implements the foregoing processes to asses these marketable securities and to return liquidity scores for these marketable securities to the seller in (near) real-time, such as in the form of a list of marketable securities ranked by liquidity score, as described below.

### 6. Ranking Securities

Block S152 of the method S100 recites ranking the set of marketable securities by liquidity score. Generally, in Block S152, the computer system can: aggregate a list of all securities held by the seller (or a list of marketable securities selected by the seller); rank these securities; and present this ranked list of securities within the seller portal for review by the seller.

In one implementation, the computer system ranks these securities by their liquidity scores, with securities with highest liquidity scores appearing first in this list.

In another implementation, the computer system can rank these securities by magnitudes that their liquidity scores changed since a previous liquidity check, with largest positive liquidity score changes appearing first in this list. For example, during a first liquidity check, the computer system can implement methods and techniques described above to: access historical trading result data for a first corpus of securities traded on the auction platform in Block Silo; access characteristics of the first corpus of securities in Block S112; assign liquidity scores to securities in this first corpus of securities at time of auction on the auction platform based on historical trading result data for the first corpus of securities in Block S120; and construct a first liquidity model representing correlations between characteristics and liquidity scores of securities in the first corpus of securities in Block S130. During this first liquidity check, the computer system can calculate a first liquidity score of each security held by the seller (or each marketable security indicated by the seller) at the time of the first liquidity check based on characteristics of these securities and the first liquidity model in Block S150 and then rank these securities by absolute liquidity score in Block S152. However, the computer system may have calculated low liquidity scores for some (or many, all) of these securities during this first liquidity check, and the seller may elect to forego auctions for these low-scoring securities. Later during a second liquidity check (e.g., hours, days, weeks, or months later), the computer system can repeat this process to again: access historical trading result data for a second corpus of securities traded on the auction platform (such as including securities traded before and after the first liquidity check) in Block Silo; access characteristics of the second corpus of securities in Block S112; assign liquidity scores to securities in this second corpus of securities at time of auction on the auction platform based on historical trading result data for the second corpus of securities in Block S120; and construct a second liquidity model (or refine the first liquidity model) representing correlations between characteristics and liquidity scores of securities in the second corpus of securities in Block S130. During this second liquidity check, the computer system can calculate a second liquidity score of each security held by the seller (or each marketable security indicated by the seller) at the time of the second liquidity check based on characteristics of these securities and the second liquidity model in Block S150 and then rank these securities by differences in their first and second liquidity scores (or by a combination of absolute liquidity score and liquidity score difference) in Block S152. Therefore, if the computer system has historically calculated low liquidity scores for a particular security (e.g., if the computer system predicts the particular security will receive few bids with high variance and low likelihood of clearing the seller's reserve) but the computer system now calculates a greater liquidity score for the particular security, the computer system can assign a high rank to the particular security, thereby alerting the seller of improved opportunity to trade the particular security and enabling the seller to take advantage of current market conditions to trade a security that has historically exhibited less liquidity.

The seller may then select a particular security—from this ranked list of securities—to auction on the auction platform, such as based on: the liquidity score of this security; the liquidity score of this security relative to other securities in this list; or a change (e.g., an increase) in liquidity score of this security from a previous liquidity score calculated for this security during a previous liquidity check.

### 6.1 Ranking Update

Furthermore, the computer system can automatically reassess liquidity of all or select marketable securities held by the seller over time based on new data from current and recently-completed BWIC auctions for other securities held by sellers on the platform and/or based on updated liquidity models thus generated by the computer system. For example, the computer system can repeat the foregoing process to assess securities held by the seller—such as in real-time, on one-minute or 30-minute intervals, once per hour, or twice daily, etc.—and update rankings of these securities identified in the seller portal.

### 7. BWIC Trigger

Block S160 of the method S100 recites prompting the seller to elect a subset of securities from the ranked set of marketable securities to auction. Generally, in Block S160, the computer system can automatically notify the seller of a high-liquidity security or otherwise prompt the seller to initiate a BWIC auction for a security held by the seller based on liquidity scores of these securities calculated in Block S150.

### 7.1 Push Notifications

In one implementation shown in FIG. 1, the computer system prompts or enables the seller to define BWIC trigger conditions in her account on the auction platform, such as: a minimum number of securities, proportion of securities held, or total security size to list at auction per unit time (e.g., one auction per week, two auctions per year); a minimum liquidity score threshold at which to trigger an auction; a minimum final bid price or margin predicted for one security or a group of securities; etc. Then, after calculating liquidity scores for securities held by the seller, the computer system compares these liquidity scores to these BWIC trigger conditions to determine whether any of these securities meet the current BWIC trigger conditions specified by the seller.

Upon identifying a subset of securities—held by the seller—that meet at least one of the BWIC trigger conditions specified by the seller, the computer system can generate a ranked, filtered list of this subset of securities, such as including identification of each security and the liquidity score of each security. The computer system can then: push this ranked, filtered list of securities to the seller in (near) real-time, such as via a notification within the seller portal; and prompt the seller to elect and confirm one or multiple securities in the ranked, filtered list for auction on the auction platform. The computer system can then initiate the auction process, as described below, for each security thus elected for auction by the seller.

In one example, the seller records threshold liquidity scores and/or reserve prices for securities listed in her account. Over time, the computer system: refines the liquidity model based on results of additional security auctions completed on the auction platform; and recalculates liquidity scores for the seller's securities and/or revises final bid price predictions for these securities based on changing market conditions and revised liquidity models. Then, if the liquidity score of a particular security held by the seller exceeds a threshold liquidity score assigned to this particular security by the seller or exceeds a general liquidity score threshold set by the seller, the computer system can push a notification for this change in liquidity score for the particular security to the seller and prompt the seller to confirm an auction for the particular security. Similarly, if final bid price predicted for a particular security exceeds a reserve assigned to this particular security by the seller, the computer system can push a notification for this prediction to the seller and prompt the seller to confirm an auction for the particular security.

### 7.2 Automatic BWIC Trigger

Alternatively, the computer system can automatically initiate a BWIC auction for a particular security held by the seller in response to calculating a liquidity score that exceeds a threshold liquidity score previously set by the seller and/or in response to estimating a final bid price that exceeds a reserve or target final bid price set by seller for the security.

### 7.3 BWIC Filter

In one variation, rather than automatically initiate a BWIC auction or prompt the seller to initiate a BWIC auction for a particular security in response to calculating a liquidity score that exceeds a threshold liquidity score, the computer system can prompt the seller to delay or withhold a BWIC auction for a security characterized by a low liquidity score or by a liquidity score that falls below a threshold liquidity score. For example, the computer system can: execute the foregoing methods and techniques and calculate a liquidity score for a security after the security is selected for an upcoming BWIC auction by the seller; and then prompt the seller to delay a BWIC auction for this security (e.g., and elect an alternate security instead) if the liquidity score for the security is below a preset liquidity score threshold, has fallen over a recent period of time, or is predicted to increase in the future.

### 8. BWIC Rules and Parameters

Block S170 of the method S100 recites, in response to election of a particular security from the ranked set of marketable securities to auction by the seller, selecting a rule profile, from a set of predefined rule profiles, based on a characteristic of the seller, wherein the predefined rule profile specifies rules for improvement of bids by bidder and distribution of feedback to bidders during an auction for the particular security. Generally, in Block S170, when initiating the auction process for a security elected for auction by the seller, the computer system can interface with the seller to define parameters and rules for auctioning the security.

### 8.1 Timing Parameters

In one implementation, the computer system prompts the seller to specify time-related parameters of the BWIC auction, such as including: a date and time of auction start (e.g., an immediate auction start or an auction start on next business day at 10 AM or market open); time of bids due (e.g., an auction end time, such as two hours after auction start); a post-auction time period over which bids are not subject to change (e.g., bids must be firm and not subject to change until two hours after auction end).

### 8.2 Pre-Auction Rules

The computer system can also prompt the seller set pre-auction rules, such as including whether to enable pre-auction trading to accept bids prior to start of auction. In this implementation, the auction platform can automatically market the security to all or select whitelisted broker-dealers and end-users prior to auction start and collect pre-auction bids from these entities.

In one implementation, the computer system retrieves bid histories of an investor on the auction platform, such as including bid prices, bid depths, and/or bid improvement during past auctions for particular securities of known sizes, ratings, and/or other characteristics. The computer system then implements methods and techniques similar to those described above to derive correlations between: whether the investor places a bid, bid prices, bid depths, and/or bid improvement by the investor during auction for securities; and sizes, ratings, and/or other characteristics of these securities. The computer system compiles these correlations into a bidder model for the bidder that predicts likelihood of bid submission, bid depth, and/or bid improvement by this investor during an auction for a security based on characteristics of this security. The computer system can repeat this process for each other investor on the auction platform and can update these bidder models over time as these investors place bids (and withhold bidding) on subsequent securities auctioned on the auction platform.

For the security thus elected for auction on the auction platform, the computer system can predict depths of bids entered by investors on the auction platform during an auction for this security based on their corresponding bidder models (which are generated based on bids submitted by these investors during previous auctions for other securities) and characteristics of the security. The computer system can then: identify a subset of investors—in this population of investors—associated with highest probabilities of bidding on the security, greatest predicted depths of bids, and/or most frequency bid improvement during the auction for the security; and prompt the seller to enable pre-auction bidding (or “early trading”) for the security among this subset of investors. If the seller confirms pre-auction bidding for these investors, then the computer system can: transmit prompts to view auction details for the security to the subset of investor via instances of the bidder portal executing on their computing devices; activate pre-auction bidding on the security among this subset of investors prior to an official timed start of the auction; and then implement methods and techniques described below to return feedback to these investors responsive to receipt of pre-auction bids from these investors.

### 8.3 Bidders

The computer system can also interface with the seller to add additional broker-dealers to a whitelist and/or blacklist for the BWIC auction. For example, the computer system can serve—via the seller portal—a list of all broker-dealers and end-users on the auction platform, such as sorted by historical tranche and bid size, bid frequency, and/or whether the broker-dealer or end-user previously bid on securities held by the seller. The seller may then select investors from this list to add to a blacklist limiting participation of broker-dealers and end-users: for the current BWIC auction and any future BWIC auction for a security held by the seller; or for the upcoming BWIC auction specifically.

Additionally or alternatively, the seller may enter bid limits for broker-dealers and end-users, such as for any security held by the seller generally or for specific securities held by the seller. The computer system can then record identifiers of these broker-dealers and end-users to a corresponding whitelist and blacklist for this upcoming BWIC auction. The computer system can also automatically populate a whitelist and blacklist for this auction based on the value of the security and permitted bid values or bid ranges enabled for these broker-dealers and end-users and/or based on stored other characteristics of the security, broker-dealers, and end-users.

### 8.4 Intra-Auction Rules

The computer system can also prompt the seller to specify or confirm intra-auction rules, such as: whether the close of auction is hard or soft; whether early trading is permitted; or whether partial orders are accepted; and/or whether a reserve price is applied.

Furthermore, the computer system can prompt the seller to specify or confirm rules related to feedback, such as: whether feedback is automatically distributed to a bidder upon receipt of a bid; a schedule for distributing feedback updates to bidders (e.g., once ten minutes prior to auction close; on a regular interval, such as once per five-minute interval during the auction); and who receives feedback during the auction (e.g., all bidders, only bidders who placed the top bids, only bidders who placed bids exceeding a reserve). For example, the seller may specify that real-time bid feedback is to be provided for each bid in the top-five bids received during the auction. Similarly, the seller may specify that feedback is to be provided to the top-five bidders on a five-minute interval throughout the full duration of the auction, such as including confirmation that a bid placed by a top-five bidder remains in the top-five bids received or was superseded by a more recent bid.

The computer system can also prompt the seller to specify or confirm rules related to bid improvements, such as: whether bid improvements are permitted; when bid improvements are permitted (e.g., once per bidder during the auction; once per bidder at ten minutes to auction close; once per 40-minute interval per bidder until auction close; or unlimited improvement); and who is permitted to enter bid improvement (e.g., all viewers; all bidders; all bidders with bids over the reserve price; all bidders with full orders; all bidders with full orders over the reserve price; or bidders with top 1, 3, or 5 bids prices).

### 8.4 Post-Auction Color Policy

Similarly, the computer system can prompt the seller to specify or confirm post-auction rules for distribution of color to bidders, action viewers, or the market more generally. For example, the computer system can prompt the seller to specify: distribution of auction result color for the highest bidder and/or the auction winner only (or “cover”) but no distribution of auction result color to the broader market; distribution of color only on traded positions and cover at an exact level of the security; distribution of color only on traded positions and cover within a threshold range of the level (e.g., 90%) of the security; distribution of color on all positions and cover at an exact level of the security (e.g., a best bid at the exact level of the security); or distribution of color on all positions and cover within a threshold range of the level of the security (e.g., a best bid approximating the level of the security). Similarly, the computer system can prompt the seller to specify distribution of color to: all viewers; all bidders; all bidders with bids over the reserve price; all bidders with full orders; all bidders with full orders over the reserve price; or bidders with top one, three, or five bid prices, order sizes, or combination of bid prices and order sizes.

### 8.5 Rule Profile

In this foregoing example, the computer system can: present the foregoing options to the seller, such as in the form of a list; and prompt the seller to toggle virtual buttons, select radio buttons, or enter values into text fields to set the foregoing intra- and post-auction parameters. However, the computer system can record any other intra- and post-auction parameters—for the BWIC auction for the security—specified or confirmed manually by the seller.

Alternatively, in one variation shown in FIG. 1, the computer system: stores a set of predefined rule profiles for BWIC auctions, each specifying a particular combination of feedback, color improvement, and other parameters; and interfaces with the seller to elect a particular rule profile—from this predefined set of rule profiles—or to customize a rule profile for the upcoming auction.

### 8.5.1 Manual Rule Profile Selection

In one example, the computer system can store a set of predefined rule profiles including: a high transparency profile for auctions in which a small number of bidders and/or larger frequency of partial bids are expected with lower bid variance; a high-demand profile for auctions in which a large number of bidders and/or larger frequency of partial bids are expected with higher bid variance; and an unpredictable bidder profile for auctions in which high bid variance is anticipated. In this example: the high transparency profile can specify minimal limitations on feedback distribution; the high-demand profile can specify more limitations on feedback distribution but minimal limitations on improvement; and the unpredictable bidder profile can specify that feedback be distributed to the top-three bidders only at 30-minute intervals during the auction. In this example, the computer system can: predict both a liquidity score and more specific auction characteristics based on security characteristics and current market conditions, as described above; automatically identify a particular rule profile best matched to the security based on the liquidity score and these predicted auction characteristics of the security; and then recommend this particular rule profile for the auction to the seller accordingly.

### 8.5.2 Automatic Rule Profile Selection Based on Seller Characteristics

Alternatively, the computer system can automatically assign a rule profile to the upcoming BWIC auction based on characteristics of the seller. For example, a typical portfolio rotator may desire a best (i.e., highest) price for a security but not a need to sell the security immediately. Therefore, a portfolio rotator rule profile can specify: three rounds of improvements from all bidders during an auction for the portfolio rotator's security; access to feedback for the top-five bidders during the auction; and distribution of auction update data to top-five bidders on a five-minute interval during the auction. Similarly, a casual trader may exhibit a moderately-high preference for best price but also exhibit less willingness for extended negotiations to maximize price. Therefore, a casual trader rule profile can specify: two rounds of improvements from the top-five bidders only during an auction for the casual trader's security; access to feedback for the top-three bidders during the auction; and distribution of auction update data to top-three bidders on a ten-minute interval during the auction. Furthermore, a liquidator or price discoverer may exhibit greater interest in testing market interest for a security, accessing pricing information, and achieving a reasonable price above a minimum. Therefore, a liquidator/price discoverer rule profiles can specify: one round of improvement from the top-three bidders only during an auction for the liquidator's security; access to feedback for the single highest bidder only upon receipt of a bid from this bidder that exceeds all outstanding bids; and otherwise no distribution of auction update data to bidders during the auction.

(In this variation, these predefined rule profiles can also specify post-auction rules, such as described above.)

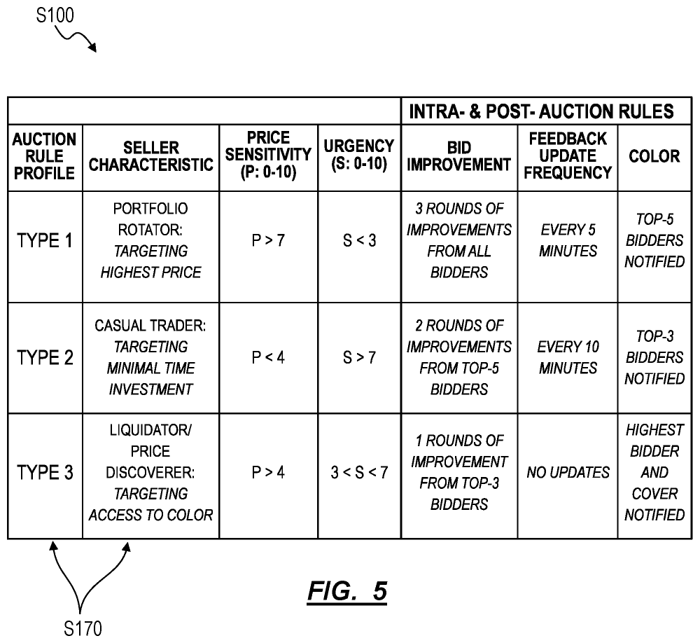

In a similar example shown in FIG. 5, the computer system can generate and store a set of rule profiles associated with ranges of seller price sensitivities and urgencies. In this example, a first rule profile in this set: can define distribution of feedback responsive to receipt of bids within a first quantity of (e.g., five) top bids; can define distribution of feedback to bidders at a first frequency (e.g., on five-minute intervals); can define a first maximum quantity of bid improvements (e.g., three rounds of bid improvements from all bidders); and can be associated with a first price sensitivity (e.g., a seller-reported price sensitivity greater than 7/10) and a first urgency (e.g., a seller-reported urgency less than 3/10). Conversely, a second rule profile in the set: can define distribution of feedback responsive to receipt of bids within a second quantity of (e.g., three) top bids less than the first quantity of top bids; can define distribution of feedback to bidders at a second frequency less than the first frequency (e.g., on ten-minute intervals); can define a second maximum quantity of bid improvements less than the first maximum quantity of bid improvements (e.g., two rounds of bid improvements from the top-five bidders); and can be associated with a second price sensitivity less than the first price sensitivity (e.g., a seller-reported price sensitivity less than 4/10) and a second urgency greater than the first urgency (e.g., a seller-reported urgency greater than 7/10). Furthermore, a third rule profile in the set: can define distribution of feedback responsive to receipt of bids within a third quantity of top bids less than the first and second quantities of top bids (e.g., a highest bid or “cover” only); can define distribution of feedback to bidders at a third frequency less than the first and second frequencies (e.g., never); can define a third maximum quantity of bid improvements less than the first and second maximum quantities of bid improvements (e.g., one round of bid improvements from the top-three bidders); and can be associated with a third price sensitivity greater than the second price sensitivity (e.g., a seller-reported price sensitivity greater than 4/10) and a third urgency greater than the first and second urgencies (e.g., a seller-reported urgency between 3/10 and 7/10).

In this example, the computer system can: query the seller for price sensitivity and urgency for trading the security; and then assign a particular rule profile—in this set of rule profiles—to the security based on the seller's reported price sensitivity and urgency for trading the security. In particular, the computer system can assign the first rule profile to the security in response to alignment between: the first price sensitivity associated with the first rule profile and a price sensitivity response returned by the seller; and the first urgency associated with the first rule profile and an urgency response returned by the seller.

### 8.5.3 Automatic Rule Profile Selection Based on Security Characteristics

Additionally or alternatively, the computer system can automatically assign a rule profile to the upcoming BWIC auction based on characteristics of the security.

For example, the computer system can generate and store a set of rule profiles associated with liquidity score ranges. In this example, a first rule profile in this set: can define distribution of feedback responsive to receipt of bids within a first quantity of (e.g., five) top bids; can define distribution of feedback to bidders at a first frequency (e.g., on five-minute intervals); can define a first maximum quantity of bid improvements (e.g., three rounds of bid improvements from all bidders); and can be associated with a first range of liquidity scores (e.g., 0.70 to 1.0). Conversely, a second rule profile in the set: can define distribution of feedback responsive to receipt of bids within a second quantity of (e.g., three) top bids less than the first quantity of top bids; can define distribution of feedback to bidders at a second frequency less than the first frequency (e.g., on ten-minute intervals); can define a second maximum quantity of bid improvements less than the first maximum quantity of bid improvements (e.g., two rounds of bid improvements from the top-five bidders); and can be associated with a second range of liquidity scores less than the first range of liquidity scores (e.g., 0.4 to 0.7). Furthermore, a third rule profile in the set: can define distribution of feedback responsive to receipt of bids within a third quantity of top bids less than the first and second quantities of top bids (e.g., a highest bid or “cover” only); can define distribution of feedback to bidders at a third frequency less than the first and second frequencies (e.g., never); can define a third maximum quantity of bid improvements less than the first and second maximum quantities of bid improvements (e.g., one round of bid improvements from the top-three bidders); and can be associated with a third range of liquidity scores less than the first and second ranges of liquidity scores (e.g., 0.1 to 0.4)

In this example, the computer system can assign the first rule profile to the security in response to the liquidity score of the security falling within the first range of liquidity scores associated with the first rule profile.

Furthermore, in this implement, the computer system can also adjust (or “tweak”) a rule profile assigned to the security based on characteristics of the seller. For example, the computer system can query the seller for price sensitivity and urgency for trading the security, such as described above. Then, after assigning a rule profile—in the set of rule profiles—to the security, the computer system can adjust a quantity of top bids that receive real-time feedback, as defined in the rule profile: proportional to a price sensitivity response entered by the seller; and/or inversely proportional to an urgency response entered by the seller. Similarly, the computer system can adjust the frequency at which feedback is distributed to bidders, as defined in the rule profile: proportional to the price sensitivity response entered by the seller; and inversely proportional to the urgency response entered by the seller. Additionally or alternatively, the computer system can adjust the first maximum quantity of bid improvements permitted for bidders, as defined in the rule profile: proportional to the price sensitivity response entered by the seller; and inversely proportional to the urgency response entered by the seller.

### 8.5.3 Parametric Rule Profile Generation Based on Security Characteristics

Additionally or alternatively, the computer system can automatically generate a profile to the upcoming BWIC auction based on characteristics of the security.

In one example, in response to the liquidity score of the security exceeding a threshold liquidity score, the computer system specifies distribution of feedback to bidders within a first duration of time (e.g., within seconds) following receipt of bids from bidders. Conversely, in response to the liquidity score of the security falling below a threshold liquidity score, the computer system can specify distribution of feedback to bidders delayed by a second duration of time greater than the first duration of time (e.g., five minutes) following receipt of bids from bidders.

Similarly, in response to the liquidity score of the security exceeding the same or other threshold liquidity score, the computer system can specify distribution of feedback within the first duration of time following receipt of bids within a first quantity of top bids (e.g., five top bids) during the auction. Conversely, in response to the liquidity score of the security falling below this threshold liquidity score, the computer system can specify distribution of feedback within the second duration of time following receipt of bids within a second quantity of top bids less than the first quantity of top bids (e.g., three top bids) during the auction.

Furthermore, in response to the liquidity score of the security exceeding the same or other threshold liquidity score, the computer system can specify a first maximum quantity of bid improvements (e.g., three bid improvements) by bidders during the auction. Conversely, in response to the liquidity score of the security falling below a threshold liquidity score, the computer system can specify a second maximum quantity of bid improvements, less than the first maximum quantity, (e.g., one bid improvement) by bidders during the auction.

The computer system can then compile these intra-auction rules into a rule profile for the security. (The computer system can implement similar methods and techniques to define post-auction rules for the security.)

Therefore, in this example, if the liquidity score of the security exceeds the threshold liquidity score, the computer system can execute the rule profile of this security during auction: by presenting a position of a bid—received from a bidder—to the bidder via the bidder portal within the first duration of time following receipt of the bid if this bid falls within the first quantity of top bids received during the auction at time of receipt; or by withholding presentation of the position of this bid to the bidder if this bid falls outside of the first quantity of top bids received during the auction at time of receipt. Similarly, if the liquidity score of the security falls below the threshold liquidity score, the computer system can execute the rule profile of this security during auction: by presenting a position of a bid—received from a bidder—to the bidder via the bidder portal after the second duration of time following receipt of the bid if this bid falls within the first quantity of top bids received during the auction at time of receipt; or by withholding presentation of the position of this bid to the bidder if this bid falls outside of the first quantity of top bids received during the auction at time of receipt. Furthermore, if the liquidity score of the security exceeds the threshold liquidity score, the computer system can limit bid submission by bidders to the first maximum quantity of bid improvements according to the rule profile. Conversely, if the liquidity score of the security falls below the threshold liquidity score, the computer system can limit bid submission by bidders to the second maximum quantity of bid improvements according to the rule profile.

The computer system can implement similar methods and techniques to define other intra- and post-auction parameters for the security based on the liquidity score of the security and to compile these parameters into a rule profile for the security.

In this implementation, rather than implement liquidity score thresholds to select these intra- and post-auction parameters for the security, the computer system can implement a parametric model to transform the liquidity score of the security and/or other characteristics of the security into intra- and post-auction parameters. The computer system can implement a parametric model to set or adjust these intra- and post-auction parameters based on characteristics of the seller, such as described above. The computer system can then compile these intra- and post-auction parameters into a custom rule profile for the security.

However, the computer system can implement any other method or technique to select, define, or customize intra- and post-auction parameters for the security.

### 8.6 Other Data

In one variation, the seller may also upload trustee documents and/or documents related to the security to the auction platform, and the computer system can present these documents in the BWIC auction listing for the security.

### 9. Reserve

In one variation, if the seller elects a reserve price for the security when setting or confirming rules for the auction, the computer system can automatically calculate a recommended reserve price for the security and present this recommended reserve price to the seller.

In one implementation, the computer system scans historical securities auctions on the auction platform for a recent auction for a set of previous securities exhibiting greatest similarities to the current security, such as previous securities: in the same CLO; the same tranche; of the same or similar size; with the same or similar intra- and post-auction rules specified; etc. The computer system can also: average or otherwise combine final auction prices for these similar, previous securities to calculate a reference auction price prediction for the current security; average or otherwise combine liquidity scores for these other securities to calculate a reference liquidity score for the current security; and calculate a difference between the reference liquidity score for these previous securities and the liquidity score for the current security. The computer system can then adjust the reference auction price prediction proportional to this liquidity score difference in order to calculate a recommended reserve price for the current security, such as: by increasing the recommended reserve price if the liquidity score of the current security exceeds the reference liquidity score (e.g., the average liquidity score of these previous securities auctioned on the platform); or by decreasing the recommended reserve price if the liquidity score of the current security is less than the reference liquidity score. The computer system can then present the recommended reserve price to the seller and prompt the seller to confirm or adjust this recommended reserve price for the upcoming BWIC auction.

Alternatively, the computer system can: identify previous securities that were recently auctioned on the platform and that exhibit characteristics and liquidity scores similar to those of the current security; and average or otherwise combine final auction prices for these previous securities to calculate a recommended reserve price for the current security. The computer system can then calculate tolerance bands for the recommended reserve price based on the liquidity score of the current security, such as by: biasing a tolerance band to less than the recommended reserve price if the liquidity score of the current set is low; decreasing a width of the tolerance band if the liquidity score of the current set is low and/or if the seller is a liquidator; biasing a tolerance band to greater than the recommended reserve price if the liquidity score of the current set is high and/or if the seller is a portfolio rotator; and/or increasing a width of the tolerance band if the liquidity score of the current set is high and/or if the seller is a portfolio rotator or casual trader. The computer system can then: present the recommended reserve price to the seller; and present the tolerance bands to the seller with an option to adjust the recommended reserve price within these tolerance bands. Finally, the seller may confirm a reserve price, such as the reserve price thus recommended by the computer system or adjusted manually by the seller within these tolerance bands.

However, the computer system can implement any other method or technique to recommend and/or record a reserve price for the security.

Furthermore, if the seller elects to offer the security without a reserve, the computer system can communicate in the subsequent auction that the security will sell without reserve.

### 10. Auction

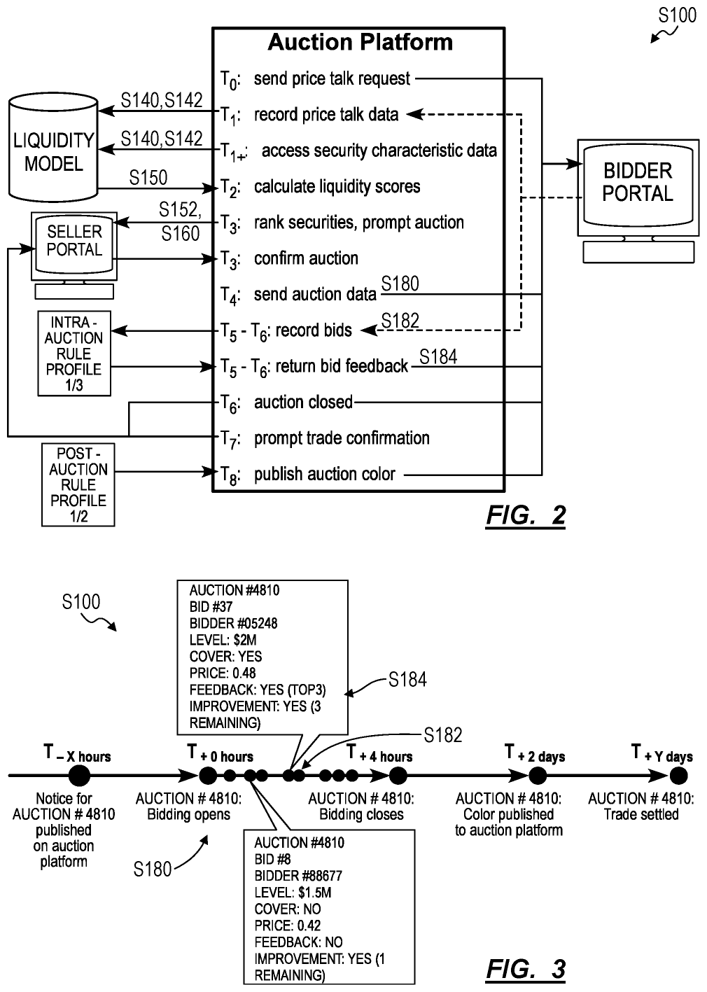

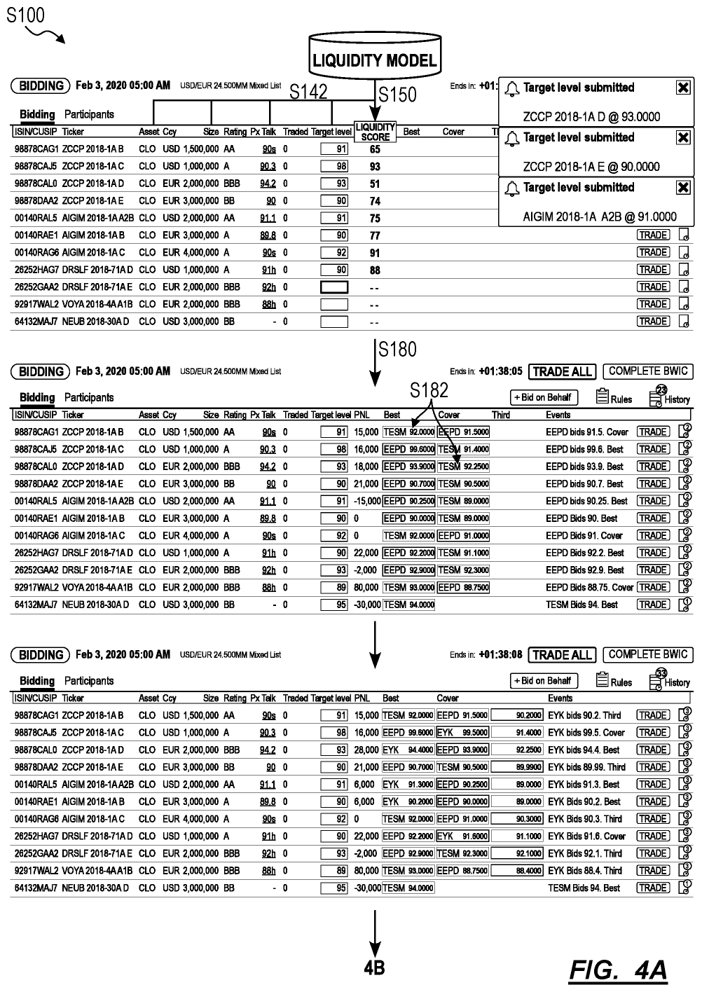

Once the seller confirms pre-, intra-, and post auction rules, confirms or disables a reserve price for the security, confirms start of a BWIC auction for the security, the computer system can: notify investors on the seller's whitelist of the auction for the security, such as by sending notifications to accounts associated with these broker-dealers and end-users with the auction platform or by sending text notifications to mobile devices associated with these broker-dealers and end-users; and post a BWIC auction for the security on the auction platform in Block S180, as shown in FIGS. 2 and 3.

### 10.1 Bid Submission and Real-Time Feedback

Throughout the auction, the computer system can collect and record bids entered by broker-dealers and end-users according to intra-auction rules in Block S182. For example, the computer system can collect bids at bidder-specified prices (or interest margins) but at the exact level of the security listed in the auction if the auction rules specify no partial orders. Alternatively, the computer system can collect bids at bidder-specified prices and bidder-specified levels of the security listed in the auction if the auction rules specify that partial orders are accepted.

The computer system can also automatically distribute feedback to bidders responsive to receipt of bids during the auction according to intra-auction rules assigned to the security, such as: by presenting a position of a bid to a bidder upon receipt of this bid—via the bidder's bidder portal—only if this bid falls within a quantity of top bids designated for real-time feedback by the rule profile of the security; or by presenting a position of a bid to a bidder with delay following receipt of this bid, if this bid fulfills a characteristic designated for delayed bid feedback by the rule profile of the security.

Furthermore, throughout the auction the computer system can push bid status notifications to select bidders and on an interval defined in the rule profile of the security. For example, the computer system can: transmit confirmation that a bidder's last bid is still a top bid received; transmit confirmation that a bidder's last bid is still within a quantity of top bids received for each bidder with a last bid in this quantity of top bids; transmit confirmation that a reserve has been met to each bidder with a last bid in this quantity of top bids; and/or transmit confirmation that the security is covered to all bidders. In another example, the computer system can: transmit updates for the top price and level bid during the auction to a small quantity of (e.g., three) bidders who placed top bids during the auction at a rate of once per five-minute interval; transmit updates for a narrow range of possible prices and levels—containing the top price and level bid during the auction—to bidders who placed bids outside of this quantity of top bids during the auction at a rate of once per ten-minute interval; and transmit updates for a wide range of possible price and levels—containing the top price and level bid during the auction—to all investors watching the auction once per hour.

However, the computer system can execute the rule profile of the security to distribute live and delayed feedback to bidders and other investors viewing the auction on the auction platform.

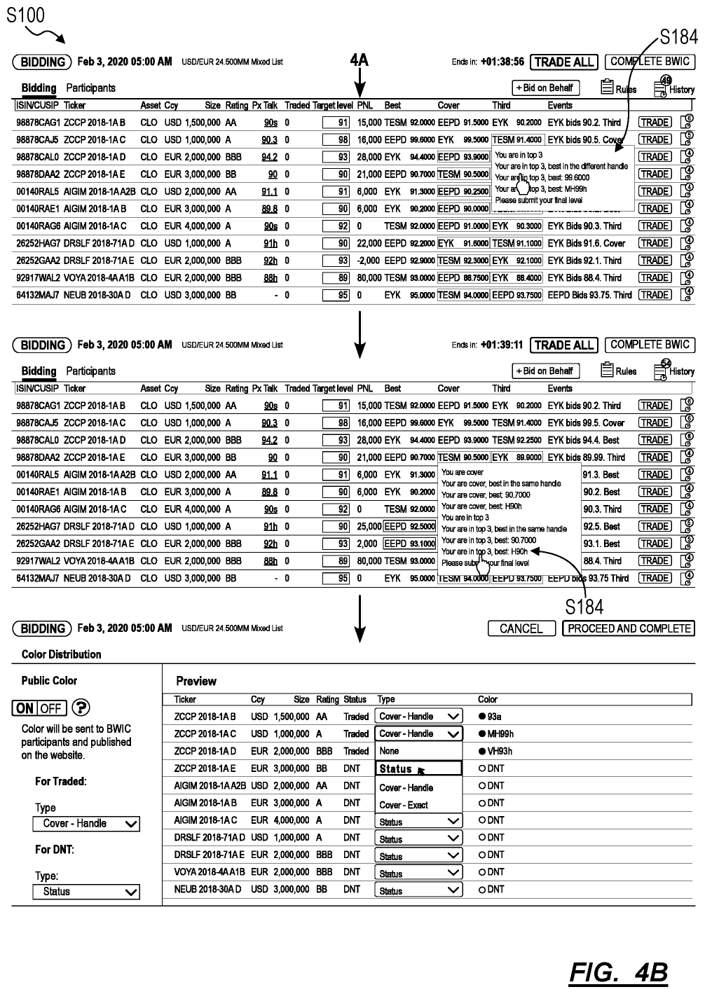

In one variation shown in FIGS. 4A and 4B, the computer system can: automatically generate a set of possible feedback options responsive to receipt of a bid based on the rule profile assigned to this auction for the security; present these feedback options to the seller; prompt or enable the seller to manually select from these feedback options; and then return a feedback option—selected manually by the seller—to this bidder via the bidder's bidder portal. In this variation, upon completion of the auction, the computer system can similarly: automatically generate a set of possible color options; present these color options to the seller; prompt or enable the seller to manually select from these color options; and then publish a color option—selected manually by the seller—to the auction platform for consumption by bidders and other investors on the auction platform.

### 10.2 Improvement

Throughout the auction, the computer system can also enable bidders to improve their bids according to the intra-auction rules. For example, the computer system can limit a number of bid revisions entered by bidders, a frequency of bid revisions entered by bidders, and which bidders are permitted to improve their bids according to these intra-auction rules.

### 11. Auction Conclusion

In one variation, upon conclusion of the auction, the computer system can notify the bidder with the best bid (e.g., best price above a reserve) at the exact level of the security and prompt the seller to confirm the trade. Once confirmed by the seller, the computer system (or an external entity) can initiate transfer of monies and securities between this bidder and seller accordingly.

Alternatively, if the intra-auction rules for the auction permit partial offers, the computer system can notify the set of bidders with best bids—above the reserve, if applicable—that, in combination, their bids cover the level of the security. The computer system can then: designate a winner of the auction and final price to be paid for this actual transaction; and/or initiate exchange of monies and securities between these bidders and the seller.

Furthermore, the computer system can automatically: publish select bid, bidder, and other data from the auction to the auction platform in accordance with post-auction rules specified by the seller.

However, the computer system can implement intra- and post-auction rules in any other way to automatically manage the BWIC auction for the security. The computer system can also handle settlement between one or more bidders and the seller in any other way responsive to a successful auction. Finally, the computer system can: refine the liquidity model based on security, market, and auction data collected during this BWIC auction; implement the foregoing methods and techniques to recalculate liquidity scores for other securities on the auction platform; repeat the foregoing processes to prompt the same and other sellers to initiate BWIC auctions for other high-liquidity-score securities; and automatically execute BWIC auctions for these securities accordingly on behalf of their holders.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method for initiating and hosting an auction for a security comprising:
accessing historical trading result data for a first corpus of securities traded on an auction platform;
accessing characteristics of the first corpus of securities;
assigning liquidity scores to securities in the first corpus of securities at time of auction on the auction platform based on historical trading result data for the first corpus of securities;
constructing a first liquidity model representing correlations between characteristics and liquidity scores of securities in the first corpus of securities;
during a first time period:
accessing characteristics of a first security held by a seller;
calculating a first liquidity score of the first security based on characteristics of the first security and the first liquidity model; and
assigning a first rule profile to the first security based on the first liquidity score of the first security, the first rule profile defining rules for distribution of feedback to bidders during an auction for the first security;
initiating the auction for the first security on the auction platform; and
during the auction for the first security on the auction platform:
recording a first bid entered by a first bidder at a bidder portal at a first time; and
distributing feedback for the first bid, via the bidder portal, to the first bidder at approximately the first time according to rules for distribution of feedback specified in the first rule profile.

2. The method of claim 1:
wherein assigning the first rule profile to the first security comprises:
in response to the first liquidity score exceeding a threshold liquidity score, selecting the first rule profile specifying distribution of feedback to bidders within a first duration of time following receipt of bids from bidders; and
in response to the first liquidity score falling below a threshold liquidity score, selecting the first rule profile specifying distribution of feedback to bidders delayed by a second duration of time following receipt of bids from bidders, the second duration of time exceeding the first duration of time; and
wherein distributing feedback for the first bid to the first bidder comprises:
in response to the first liquidity score exceeding the threshold liquidity score, presenting a position of the first bid, in a set of bids received during the auction, via the bidder portal within the first duration of time following the first time according to the first rule profile; and
in response to the first liquidity score falling below the threshold liquidity score, presenting the position of the first bid, in the set of bids received during the auction, via the bidder portal after the second duration of time following the first time according to the first rule profile.

3. The method of claim 2:
wherein assigning the first rule profile to the first security further comprises:
in response to the first liquidity score exceeding the threshold liquidity score, selecting the first rule profile further specifying distribution of feedback within the first duration of time following receipt of bids within a first quantity of top bids during the auction; and
in response to the first liquidity score falling below the threshold liquidity score, selecting the first rule profile further specifying distribution of feedback within the second duration of time following receipt of bids within a second quantity of top bids during the auction, the second quantity less than the first quantity; and
wherein distributing feedback for the first bid to the first bidder further comprises:
in response to the first liquidity score exceeding the threshold liquidity score:
in response to the first bid falling within the first quantity of top bids received during the auction by the first time, presenting the position of the first bid via the bidder portal within the first duration of time following the first time according to the first rule profile; and
in response to the first bid falling outside of the first quantity of top bids received during the auction by the first time, withholding presentation of the position of the first bid via the bidder portal according to the first rule profile; and
in response to the first liquidity score falling below the threshold liquidity score:
presenting feedback for the position of the first bid via the bidder portal after the second duration of time following the first time according to the first rule profile; and
in response to the first bid falling outside of the second quantity of top bids received during the auction by the first time, withholding presentation of the position of the first bid via the bidder portal according to the first rule profile.

4. The method of claim 2:
wherein assigning the first rule profile to the first security further comprises:
in response to the first liquidity score exceeding the threshold liquidity score, selecting the first rule profile further specifying a first maximum quantity of bid improvements by bidders during the auction; and
in response to the first liquidity score falling below the threshold liquidity score, selecting the first rule profile further specifying a second maximum quantity of bid improvements by bidders during the auction, the second maximum quantity less than the first maximum quantity; and
further comprising, during the auction for the first security on the auction platform:
in response to the first liquidity score exceeding the threshold liquidity score, limiting bid submission by the first bidder to the first maximum quantity of bid improvements according to the first rule profile; and
in response to the first liquidity score falling below the threshold liquidity score, limiting bid submission by the first bidder to the second maximum quantity of bid improvements according to the first rule profile.

5. The method of claim 1:
further comprising generating a set of rule profiles comprising:
the first rule profile:
defining distribution of feedback responsive to receipt of bids within a first quantity of top bids;
defining distribution of feedback to bidders at a first frequency;
defining a first maximum quantity of bid improvements; and
associated with a first liquidity score range;
a second rule profile:
defining distribution of feedback responsive to receipt of bids within a second quantity of top bids less than the first quantity of top bids;
defining distribution of feedback to bidders at a second frequency less than the first frequency;
defining a second maximum quantity of bid improvements less than the first maximum quantity of bid improvements; and
associated with a second liquidity score range less than the first liquidity score range;
wherein assigning the first rule profile to the first security comprises assigning the first rule profile, in the set of rule profiles, to the first security in response to the first liquidity score falling within the first liquidity score range.

6. The method of claim 5, wherein assigning the first rule profile to the first security further comprises:
querying the seller for price sensitivity and urgency for trading the first security;
adjusting the first quantity of top bids proportional to a price sensitivity response entered by the seller and inversely proportional to an urgency response entered by the seller;
adjusting first frequency proportional to the price sensitivity response and inversely proportional to the urgency response; and
adjusting the first maximum quantity of bid improvements proportional to the price sensitivity response and inversely proportional to the urgency response.

7. The method of claim 5:
wherein distributing feedback for the first bid via the bidder portal at approximately the first time comprises, in response to the first bid falling within the first quantity of top bids received during the auction by the first time, presenting a position of the first bid, in a set of bids received during the auction, via the bidder portal at approximately the first time according to the first rule profile; and
further comprising, during the auction:
updating feedback for the first bid, presented within the bidder portal, at the first frequency following the first time according to the first rule profile; and
disabling entry of additional bids by the first bidder in response to a sum of bids entered by the first bidder during the auction exceeding the first maximum quantity of bid improvements.

8. The method of claim 1:
wherein assigning the first rule profile to the first security comprises, based on the first liquidity score of the first security, assigning the first rule profile, further defining rules for distribution of color for the auction to bidders following conclusion of the auction, to the first security;
further comprising:
presenting a final bid price for the auction to the first bidder via the bidder portal according to rules for distribution of color in the first rule profile in response to the first bid submitted by the first bidder falling within a first range of bids entered during the auction;
presenting a final bid range containing the final bid price to a second bidder via a second bidder portal according to rules for distribution of color in the first rule profile in response to a second maximum bid submitted by the second bidder falling within a second range of bids less than the first range of bids entered during the auction; and
presenting confirmation of success of the auction to a third bidder via a third bidder portal according to rules for distribution of color in the first rule profile in response to a third maximum bid submitted by the third bidder falling below the second range of bids entered during the auction.

9. The method of claim 1:
further comprising, during an initial time period preceding the first time period:
accessing historical trading result data for an initial corpus of securities traded on the auction platform prior to the initial time period;
accessing characteristics of the initial corpus of securities;
assigning liquidity scores to securities in the initial corpus of securities at time of auction on the auction platform based on historical trading result data for the initial corpus of securities;
constructing an initial liquidity model representing correlations between characteristics and liquidity scores of securities in the initial corpus of securities; and
calculating an initial liquidity score of the first security based on characteristics of the first security and the initial liquidity model;
wherein accessing historical trading result data for the first corpus of securities traded on the auction platform and constructing the first liquidity model comprises constructing the first liquidity model representing correlations between characteristics and liquidity scores of securities in the first corpus of securities traded on the platform during the first time period; and
wherein initiating the auction for the first security on the auction platform comprises selecting the first security for auction on the platform in response to the first liquidity score exceeding the initial liquidity score.

10. The method of claim 1, further comprising:
querying a group of investors affiliated with an auction platform for price talk for the security; and
adjusting the first liquidity score of the first security inversely proportional to a spread of price talk returned by the group of investors for the first security.

11. The method of claim 1:
wherein accessing historical trading result data for the corpus of securities traded on the auction platform comprises accessing trade statuses of and bid prices placed during previous auctions, for securities in the corpus of securities, on the auction platform prior to the first time period;
wherein accessing characteristics of the corpus of securities comprises accessing sizes and ratings of securities in the corpus of securities;
wherein assigning liquidity scores to securities in the corpus of securities at time of auction on the auction platform comprises, for each security in the corpus of securities, assigning a post-auction liquidity score to the security:
inversely proportional to a spread of bid prices placed during a previous auction for the security; and
based on a trade status of the previous auction for the security;
wherein constructing the first liquidity model comprises constructing the first liquidity model representing correlations between:
post-auction liquidity scores assigned to securities in the corpus of securities; and
sizes and ratings of securities in the corpus of securities;
wherein accessing characteristics of the first security comprises accessing a first size and a first rating of the first security; and
wherein calculating the first liquidity score of the first security comprises calculating the first liquidity score of the first security based on:
the first size and the first rating of the first security; and
the first liquidity model.

12. The method of claim 11, wherein assigning liquidity scores to securities in the corpus of securities at time of auction on the auction platform comprises, for each security in the corpus of securities, assigning a post-auction liquidity score to the security further:
proportional to a quantity of unique bidders who placed bids during a previous auction for the security; and
proportional to a quantity of placed bids during the previous auction for the security.

13. The method of claim 1, further comprising:
predicting depths of bids entered by a population of investors on the auction platform during the auction based on bids submitted by investors in the population of investors during auctions for the first corpus of securities;
identifying a subset of investors, in the population of investors, associated with greatest predicted depths of bids during the auction;
transmitting prompts to view auction details for the first security to investors in the subset of investors via instances of the bidder portal; and
activating pre-auction bidding on the first security by investors in the subset of investors, via instances of the bidder portal, prior to start of the auction.

14. The method of claim 1:
further comprising receiving a reserve price for the first security from the seller; and
wherein calculating the first liquidity score of the first security comprises:
calculating probabilities of a distribution of final bid prices of the first security based on characteristics of the first security and the first liquidity model; and
calculating the first liquidity score of the first security inversely proportion to an integral of:
a subset of final bid prices, in the distribution of final bid prices, less than the reserve price; and
probabilities of final bid prices in the subset of final bid prices.

15. A method for initiating and hosting an auction for a security comprising:
for each security in a set of securities held by a seller:
querying a group of investors affiliated with an auction platform for price talk for the security; and
calculating a liquidity score for the security based on a spread of price talk returned by the group of investors for the security;
selecting a first security, in the set of securities, based on a first liquidity score of the first security;
assigning a first rule profile to the first security based on the first liquidity score of the first security, the first rule profile defining rules for distribution of feedback to bidders during an auction for the first security;
initiating an auction for the first security on the auction platform; and
during the auction for the first security on the auction platform:
recording a first bid entered by a first bidder at a bidder portal at a first time; and
distributing feedback for the first bid, via the bidder portal, to the first bidder at approximately the first time according to rules for distribution of feedback specified in the first rule profile.

16. The method of claim 15:
wherein assigning the first rule profile to the first security comprises, based on the first liquidity score of the first security, assigning the first rule profile, further defining rules for distribution of color for the auction to bidders following conclusion of the auction, to the first security;
further comprising:
presenting a final bid price for the auction to the first bidder via the bidder portal according to rules for distribution of color in the first rule profile in response to the first bid submitted by the first bidder falling within a first range of bids entered during the auction;
presenting a final bid range containing the final bid price to a second bidder via a second bidder portal according to rules for distribution of color in the first rule profile in response to a second maximum bid submitted by the second bidder falling within a second range of bids less than the first range of bids entered during the auction; and
presenting confirmation of success of the auction to a third bidder via a third bidder portal according to rules for distribution of color in the first rule profile in response to a third maximum bid submitted by the third bidder falling below the second range of bids entered during the auction.

17. A method for initiating and hosting an auction for a security comprising:
accessing historical trading result data for a corpus of securities traded on an auction platform;
accessing characteristics of the corpus of securities;
assigning liquidity scores to securities in the corpus of securities at time of auction on the auction platform based on historical trading result data for the corpus of securities;
constructing a liquidity model representing correlations between characteristics and liquidity scores of securities in the corpus of securities;
during a first time period:
accessing characteristics of a set of securities held by a seller;
for each security in the set of securities, calculating a liquidity score of the security based on characteristics of the security and the liquidity model; and
ranking the set of securities based on liquidity score;
following election of a first security, in the set of securities for auction, by the seller:
assigning a first rule profile to the first security, the first rule profile defining rules for bid improvement and rules for distribution of feedback to bidders during an auction for the first security; and
initiating an auction for the first security; and
during the auction for the first security:
recording a first bid, entered by a first bidder at a bidder portal, according to rules for improvement specified in the first rule profile; and
distributing feedback for the first bid, via the bidder portal, to the first bidder according to rules for distribution of feedback specified in the first rule profile.

18. The method of claim 17:
further comprising generating a set of rule profiles comprising:
the first rule profile:
defining distribution of feedback responsive to receipt of bids within a first quantity of top bids;
defining distribution of feedback to bidders at a first frequency;
defining a first maximum quantity of bid improvements; and
associated with a first price sensitivity and a first urgency;
a second rule profile:
defining distribution of feedback responsive to receipt of bids within a second quantity of top bids less than the first quantity of top bids;
defining distribution of feedback to bidders at a second frequency less than the first frequency;
defining a second maximum quantity of bid improvements less than the first maximum quantity of bid improvements; and
associated with a second price sensitivity less than the first price sensitivity and a second urgency greater than the first urgency;
wherein assigning the first rule profile to the first security comprises:
querying the seller for price sensitivity and urgency for trading the first security; and
assigning the first rule profile, in the set of rule profiles, to the first security based on alignment between:
the first price sensitivity associated with the first rule profile and a price sensitivity response returned by the seller; and
the first urgency associated with the first rule profile and an urgency response returned by the seller.

19. The method of claim 18, wherein assigning the first rule profile to the first security further comprises:
adjusting the first quantity of top bids proportional to a first liquidity score of the first security;
adjusting the first frequency proportional to the first liquidity score of the first security; and
adjusting the first maximum quantity of bid improvements proportional to the first liquidity score of the first security.

20. The method of claim 17:
further comprising, during an initial time period preceding the first time period:
accessing historical trading result data for an initial corpus of securities traded on the auction platform prior to the initial time period;
accessing characteristics of the initial corpus of securities;
assigning liquidity scores to securities in the initial corpus of securities at time of auction on the auction platform based on historical trading result data for the initial corpus of securities;
constructing an initial liquidity model representing correlations between characteristics and liquidity scores of securities in the initial corpus of securities; and
for each security in the set of securities, calculating an initial liquidity score of the security based on characteristics of the security and the initial liquidity model;
wherein accessing historical trading result data for the first corpus of securities traded on the auction platform and constructing the first liquidity model comprises constructing the first liquidity model representing correlations between characteristics and liquidity scores of securities in the first corpus of securities traded on the platform during the first time period; and
wherein ranking the set of securities comprises ranking the set of securities based on differences between liquidity score during the first time period and initial liquidity score during the initial time period.
